(19) United States
(12) Patent Application Publication
(10) Pub. No.: US 2010/0287022 A1
(43) Pub. Date: Nov. 11, 2010

(54) SCHEDULING AND MANAGING RESOURCES BASED ON ACT UP RANK

(76) Inventors: Rene Pfeiffer, Dresden (DE); Frank Haschick, Dresden (DE)

Correspondence Address: SAP AG, 3410 HILLVIEW AVENUE, PALO ALTO, CA, 94304, US

(21) Appl. No.: 12/435,417

(22) Filed: May 5, 2009

(51) Int. Cl. G06Q 10/00

(52) U.S. Cl. 705/9; 705/7

(57) ABSTRACT

Disclosed are methods and systems for generating a potential act up rank of an employee based on a current rank and one or more qualifications of the employee. The method and system receiving the current rank and the one or more qualifications associated with an employee from a workforce management application. An employee hierarchy table is updated with the current rank and the one or more qualifications of the employee. A potential act up rank is determined based on the current rank and the one or more qualifications of the employee. The potential act up rank specifies eligibility of the employee to perform an act up task. The potential act up rank is updated in the employee hierarchy table.

### FIELD OF THE INVENTION

The invention generally relates to organizational resource scheduling.

### BACKGROUND OF THE INVENTION

Resource scheduling facilitates an organization to plan, organize and deliver services to meet the demands more efficiently. More specifically, resource scheduling provides resource planners with key scheduling data that enables availability of service resources to be monitored at a glance by supporting flexible views on resource, demand and task data.

Through resource scheduling, employees are assigned shifts and work schedules for a task according to their availability, preferences and qualifications. Currently, scheduling tasks to an employee includes identifying the qualifications associated with the employee and assigning task based on their qualifications. In some organizations such as the police, fire brigade and the armed forces, assignments of resources are driven by requirements that the deployed force have a particular mix of ranks to accomplish a task. However, at a given time the exact mix of ranks needed for a task may not be readily available. Typically, employees of a certain rank or level are required to have minimum level of qualifications but it is also likely that at times a person can move up or down in hierarchy to take on a role other than their primary role when the need arises.

Thus, there is a need for methods of determining resource allocation based on a combination of the current rank and the qualifications of employees. This need is more pronounced when the employee has to fill in to perform a task which requires higher qualifications and rank than his current rank (e.g., act above their rank or act up). Also, restrictions such that only a next rank in the hierarchy can be assigned to the employee have to be taken into account.

### SUMMARY OF THE INVENTION

Disclosed are methods and systems for generating a potential act up rank of an employee based on a current rank and one or more qualifications of the employee. The methods and systems include receiving the current rank and the one or more qualifications associated with an employee from a workforce management application. An employee hierarchy table is updated with the current rank and the one or more qualifications of the employee. A potential act up rank is determined based on the current rank and the one or more qualifications of the employee. The potential act up rank specifies eligibility of the employee to perform an act up. The potential act up rank is updated in the employee hierarchy table

In an embodiment, the current rank and the one or more qualifications of the employee are compared with the potential act up rank at the employee hierarchy table. An act up rank of the employee is assigned on fulfilling the eligibility criteria required by the potential act up rank.

Additional features and advantages will be made apparent from the following detailed description of illustrated embodiments, which proceeds with reference to the accompanying drawings.

### BRIEF DESCRIPTION OF THE DRAWINGS

A better understanding of embodiments of the invention are illustrated by examples and not by way of limitation, the embodiments can be obtained from the following detailed description in conjunction with the following drawings, in which:

FIG. 1 illustrates an exemplary resource scheduling application according to an embodiment of the invention.

FIG. 2A is a flow diagram illustrating an exemplary process for generating a potential act up rank of an employee based on a current rank and one or more qualifications of the employee according to an embodiment of the invention.

FIG. 2B is a flow diagram illustrating an exemplary process for assigning an act up rank of an employee according to an embodiment of the invention.

FIG. 3 illustrates an exemplary hierarchy in a police force according to an embodiment of the invention.

FIG. 4 is a flow diagram illustrating an exemplary process for assigning task based on the act up rank according to an embodiment of the invention.

FIG. 5 illustrates an exemplary weekly schedule of a list of employees in the scheduling application according to an embodiment in the invention.

FIG. 6 illustrates an exemplary weekly schedule of an individual employee according to an embodiment of the invention.

FIG. 7 is an exemplary block diagram for generating a potential act up rank of an employee based on a current rank and one or more qualifications of the employee according to an embodiment of the invention.

### DETAILED DESCRIPTION

In resource scheduling, employees are assigned shifts and work schedules based on their availabilities, preferences and qualifications. There are circumstances where the employees have to perform tasks which need a higher rank and qualifications than their current rank and current qualifications. Currently, workforce management (WFM) application recognizes the qualifications of an employee but does not identify a current rank and an act up rank of the employee. Assigning shifts and work schedules to the employee based on the current rank, qualifications and act up rank results in efficient resource scheduling. Disclosed herein are methods and systems to generate a potential act up rank of the employee based on a current rank and one or more qualifications of the employee. The current rank of the employee may be defined as a position that is held by the employee in an organization. The potential act up rank of the employee may be defined as a rank which enables the employee to work in higher positions, which requires qualifications or skill sets more than is required for their current rank. The current rank and the one or more qualifications of the employee are stored in an employee hierarchy table. The employee hierarchy table is updated with the potential act up rank and qualifications associated with the potential act up rank. For an employee to perform the act up, the employee should possess the qualifications associated with the potential act up rank.

In an embodiment, on satisfying the qualifications required to perform the potential act up rank, the act up rank for the employee is determined. The employee hierarchy table also indicates a level up to which the employee can act up.

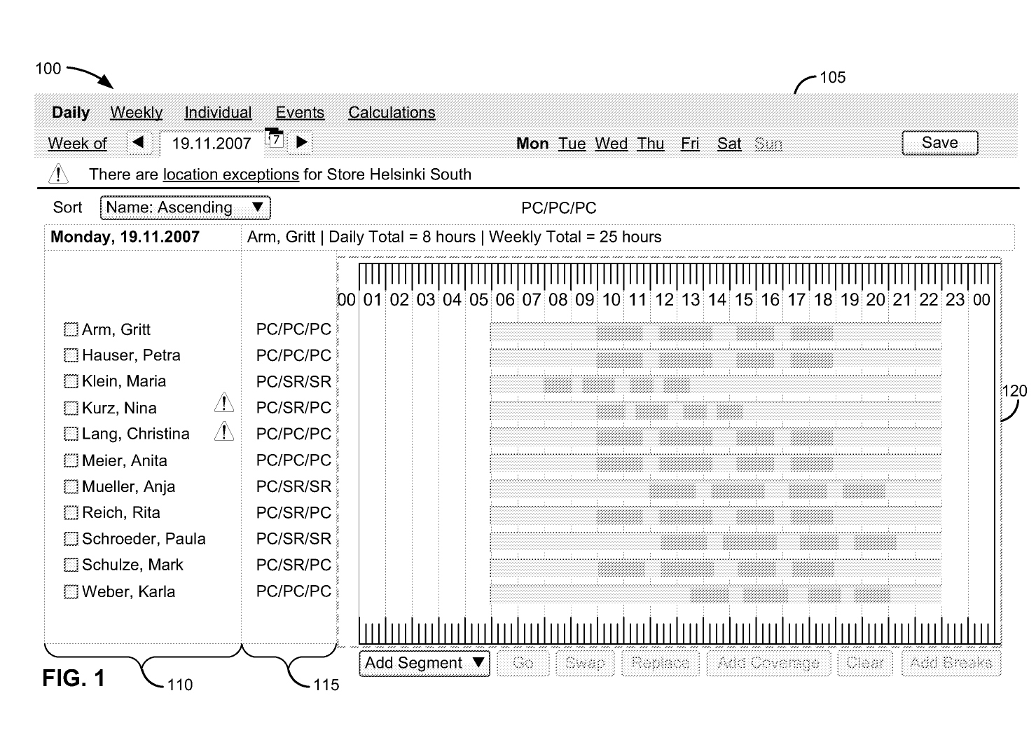

FIG. 1 illustrates an exemplary resource scheduling application according to an embodiment of the invention. Consider a business scenario 100 illustrating a schedule for a police force. The schedule includes a scheduling screen 105, an employee list 110 and a rank table 115. The scheduling screen 105 displays the schedule of employee list 110 for the day “Monday”. Each employee has rank entries associated with them in the rank table 115. The rank table 115 illustrates in order, a current rank, an act up rank and a scheduled rank of the employee. The current rank of the employee specifies the current position of the employee in the police force. The potential act up rank of the employee specifies a level up to which the employee can act up. For an employee to act up to perform at a higher position, the employee has to satisfy criteria required to perform the act up. A particular employee's act up rank can be determined based on comparing eligibility required for the ranks such as qualifications (e.g., education, certifications, etc.) and skill set (e.g., ability to handle a special tool, etc.) to employee's actual qualifications and skill set. The scheduled rank of the employee specifies the rank associated with the employee for a specific day.

For example, the current rank of employee Rita Reich is as a police constable (PC). Rita Reich also satisfies the eligibility criteria required to act up as a sergeant (SR). The scheduled rank of Rita Reich for Monday is that of a PC. Consider another example of employee Maria Klein, the current rank of Maria Klein is PC, she has satisfied the eligibility criteria to perform act up as a SR. The scheduled rank of Maria for Monday is that of SR. In this scenario, though both Rita and Maria have the capability to act up as a sergeant, if only one SR rank person is needed, Maria may be preferred over Rita for having some additional qualifications, such as skill set or better experience to perform a specific task than Rita.

The scheduling screen 105 also includes action buttons such as add segment, go, swap, replace, add coverage, clear and add breaks. The action button “add segment” enables a scheduler to add a work segment in the schedule of the employee. The action button “swap” enables a scheduler to select the employees from the employee list 110 and swap the schedule of the employees. The action button “replace” enables the scheduler to replace an employee in the employee list 110 with some other employees taking into account of their availabilities and skills. The “clear” action button enables a scheduler to clear a schedule associated with the employee in the employee list 110 by selecting an employee. The “add coverage” action button enables a scheduler to add a shift of an employee by selecting the employee and move the newly created shift by drag and drop function. The “add breaks” action button enables a scheduler to include break timings of the employee in the schedule according to break schedule rules. In an embodiment, the names in employee list 110 can be sorted using a sort option. For example, the employee list 110, which includes a list of names of the employees, can be sorted in an ascending order or a descending order.

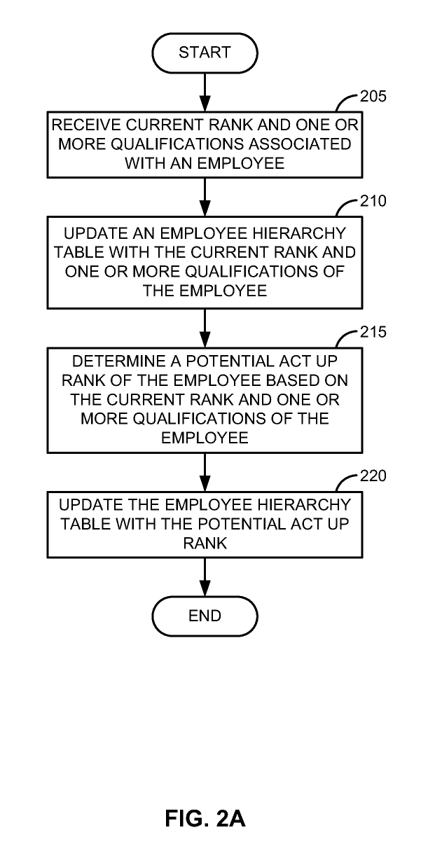

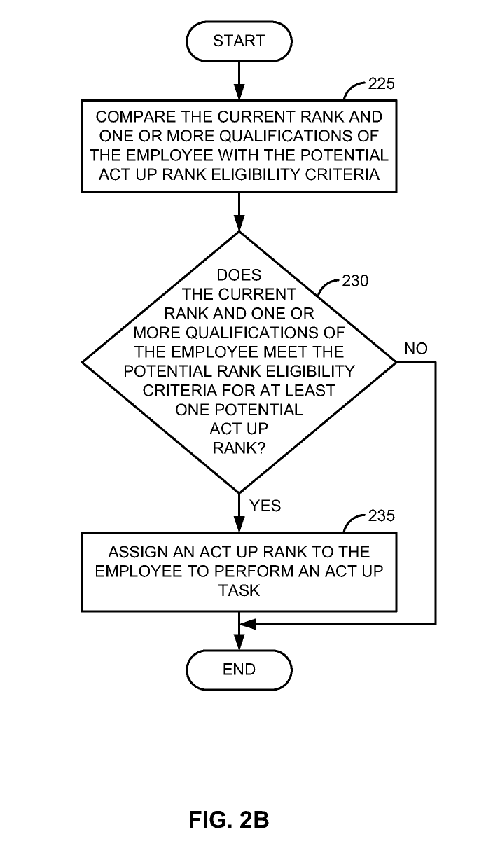

FIG. 2A is a flow diagram illustrating an exemplary process for generating a potential act up rank of an employee based on a current rank and one or more qualifications of the employee according to an embodiment of the invention. At process block 205, a current rank and one or more qualifications associated with an employee is received from a workforce management application. An employee hierarchy table is updated with the current rank and the one or more qualifications of the employee at process block 210. The employee hierarchy table is maintained separately from the employee record maintained in the workforce management application. The employee hierarchy table may be stored in a data store. At process block 215, a potential act up rank of the employee is determined based on the current rank and the one or more qualifications of the employee. The potential act up rank specifies an eligibility of the employee to perform an act up task. At process block 220, the employee hierarchy table is updated with the potential act up rank. The potential act up rank has predetermined qualifications and skill set associated with it.

FIG. 2B is a flow diagram illustrating an exemplary process for assigning an act up rank of an employee according to an embodiment of the invention. At process block 225, the current rank and the one or more qualifications of the employee is compared with the potential act up rank eligibility criteria. The process proceeds to decision block 230. At decision block 230, if the current rank and the one or more qualifications of the employee meets the potential act up rank eligibility criteria, then the process proceeds to process block 235. The potential act up rank eligibility criteria should at least be met for at least one potential act up rank. One or more potential act up ranks are identified for those employees whose eligibility criteria is met or exceeded by the current rank and the one or more qualifications of the employee. At process block 235, an act up rank of the employee is assigned to the employee to perform an act up task.

At decision block 230, if the current rank and the one or more qualifications of the employee do not meet the potential act up rank eligibility criteria, then the process ends.

In an embodiment the act up rank is updated to the employee hierarchy table. In another embodiment, the act up rank is updated to a rank table in a scheduling application. A user interface of a scheduling application displaying a rank table is updated accordingly. In the scheduling application, a schedule associated with the employee is evaluated to determine if the employee is available to perform a task requiring a specific skill set. While scheduling the task, the current rank, qualifications, preferences and availability of the employee are evaluated by the scheduler.

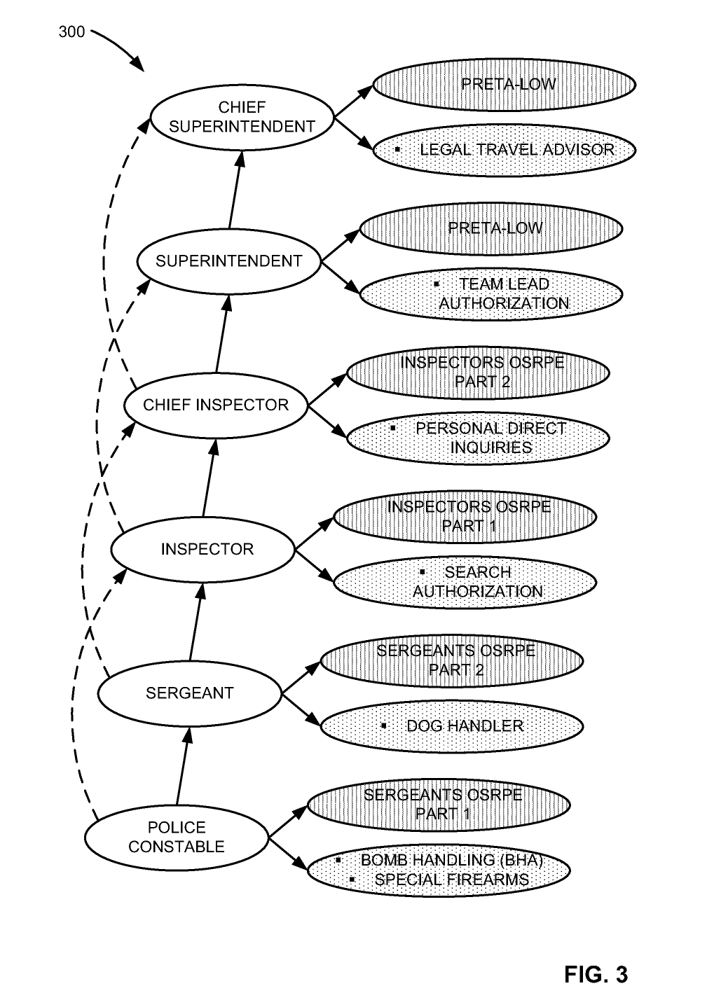

FIG. 3 illustrates an exemplary hierarchy in a police force according to an embodiment of the invention. The exemplary hierarchy 300 depicts six ranks in the police force. Each of the ranks in the hierarchy has qualifications and skill sets associated with it. The hierarchy shows that a police constable is the sixth rank in the hierarchy. The skill sets associated with the police constable are specialization in “bomb handling” and handling “special fire arms”. The qualification required for the police constable to perform an act up is “Sergeants Objective Structured Performance-Related Examination (OSPRE) Part 1”. If the police constable has this act up qualification, then he or she can act up as a Sergeant. The skill set required for the act up may be experience in performing tasks related to the rank of sergeant.

The fifth rank in the hierarchy is a sergeant. The skill set associated with sergeant is specialization as a “dog handler”. For a sergeant to act up as inspector, the sergeant needs to have the qualification of “Sergeants OSPRE Part 2”. If the sergeant has this requirement he may act up as an inspector.

The fourth rank in the hierarchy is inspector. The skill set associated with the inspector is specialization in “search authorization”. For an inspector to act up to the position of a chief inspector, the inspector should satisfy the criteria required for the position of chief inspector. The qualification required for chief inspector is “Inspectors OSPRE Part 1”. If this requirement is met then the inspector can act up as a chief inspector.

The third rank in the hierarchy is chief inspector. The skill set associated with the chief inspector is specialization in “personal direct enquiries” and the qualification required for the chief inspector to act up to a superintendent is “Inspectors OSPRE Part 2”.

The second rank in the hierarchy is superintendent. The skill set associated with the superintendent is “team lead authorization” and the qualification required for the superintendent to act up to a chief superintendent is “PRETA Low”.

The first rank in the hierarchy is chief superintendent. The skill set associated with the chief superintendent is “legal travel advisor” and the qualification is “PRETA Low”.

In an embodiment, for an employee to act up, the employee may need to have a prior experience in the tasks performed by the act up rank. In another embodiment, an employee having a sixth rank may perform up to the tasks of the third rank if the employee satisfies the eligibility criteria required for the third rank. This is denoted by the dotted arcs in FIG. 3. For example, if a police constable has a skill set of “search authorization” and has “Sergeants OSPRE Part 2” requirement, then he may act up as an inspector.

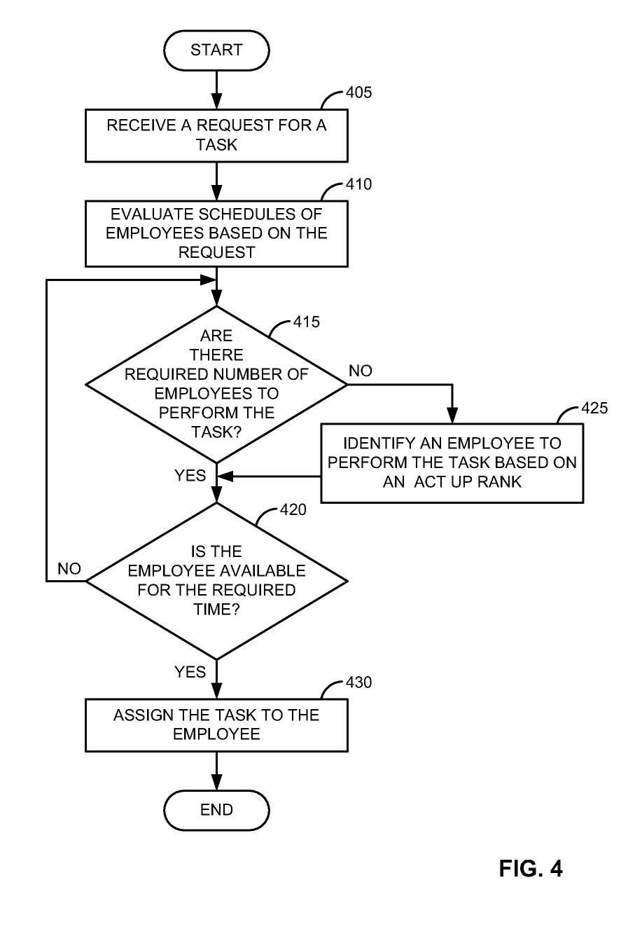

FIG. 4 is a flow diagram illustrating an exemplary process for assigning a task based on the act up rank according to an embodiment of the invention. At process block 405, a request for task for is received. The request may include details such as the number of the employees required to perform the task, the skill set or experience required to perform the task. At process block 410, based on the request, schedules of the employees are evaluated. At decision block 415, it is checked if there are required number of employees available to perform the task. If there are required numbers of employees, then the process proceeds to decision block 420. At decision block 420, it is checked if the employees are available for the required time. If the employees are available for the required time, the process proceeds to process block 430. At process block 430, the task is assigned to the employees.

At decision block 415, if there are no required numbers of employees to perform the task, the process proceeds to process block 425. At process block 425, an employee is identified to perform the task based on an act up rank. The process proceeds to decision block 420 to check if the employee is available for the required time. If the employee is available for the required time the process proceeds to process block 430 to assign the task to the employee. At decision block 420, if the employee is not available for the required the process proceeds back to decision block 415 to identify another employee based on the potential act up rank.

Consider a business scenario explaining the above mentioned process in detail. A request is received to perform a task. The received request specifies 5 police constables, 2 inspectors and 1 chief inspector. By evaluating the schedules of the employees, it is found that the required numbers of police constables are available to perform the task on a scheduled day. The police constables are also available to perform the task at a required time. So, the identified police constables are assigned with the task.

When evaluating the schedules for the 2 inspectors, it is found that there is only one employee A with the current rank as “inspector” available to perform the task. Then, the schedule of employee A is checked if the employee A can perform the task at a required time. Employee A is available for the required time. So employee A is assigned as the first inspector to perform the task. Now, there is a requirement for a second inspector in the task. A rank table in the scheduling application is checked to identify an employee who can perform up to the act up position of the inspector. From the rank table it is identified that an employee B with a current rank as a police constable can act up as the inspector. Employee B is also available for the required time, then employee B is assigned as the second inspector to perform the task.

When evaluating the schedules for the chief inspector, it is found that there are employees with the current rank as chief inspector available. But they are not available for the required time. Then, the rank table is checked to find if there are any other employees who can act up as a chief inspector. There may be few employees with the current rank as inspector who can act up as a chief inspector. But again, they are also not available for the required time. There is one employee C who has the current rank of a sergeant who can perform up to act up position of the chief inspector. The employee C is also available for the required time. Employee C is assigned as a chief inspector to perform the task.

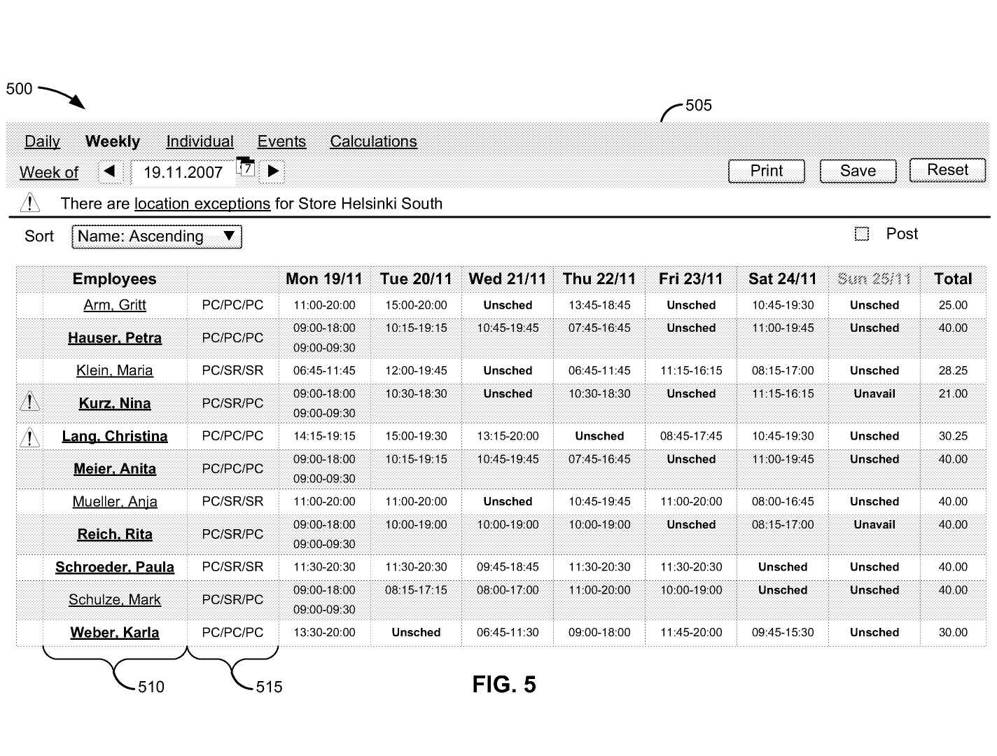

FIG. 5 illustrates an exemplary weekly schedule of a list of employees in the scheduling application, according to an embodiment in the invention. At business scenario 500, the weekly scheduling screen 505 displays employee list 510 in the first column. The scheduling screen 505 includes schedules of one or more employees. A rank table 515 in order including a current rank, an act up rank and a scheduled rank associated with the employee is displayed in the second column of the weekly scheduling screen 505. Columns 3 to 7 display the weekly schedule of the employees. Column 8 displays the total number of hours assigned to each of the employees. For example, employee Mark Schulze's current rank is PC, he can act up as a sergeant, but for the entire week he is scheduled to work as PC. Mark Schulze's weekly schedule shows that he is not scheduled for work on Saturday and Sunday. In an embodiment, when there is an emergency, Mark may be assigned to work as a sergeant on Saturday or Sunday if employees with current rank as sergeant are not available on those particular days.

In an embodiment, the columns of the employee list and the columns of the rank table can be sorted using a sort option. For example, the employee list, which includes a list of names of the employees, can be sorted in an ascending order or a descending order.

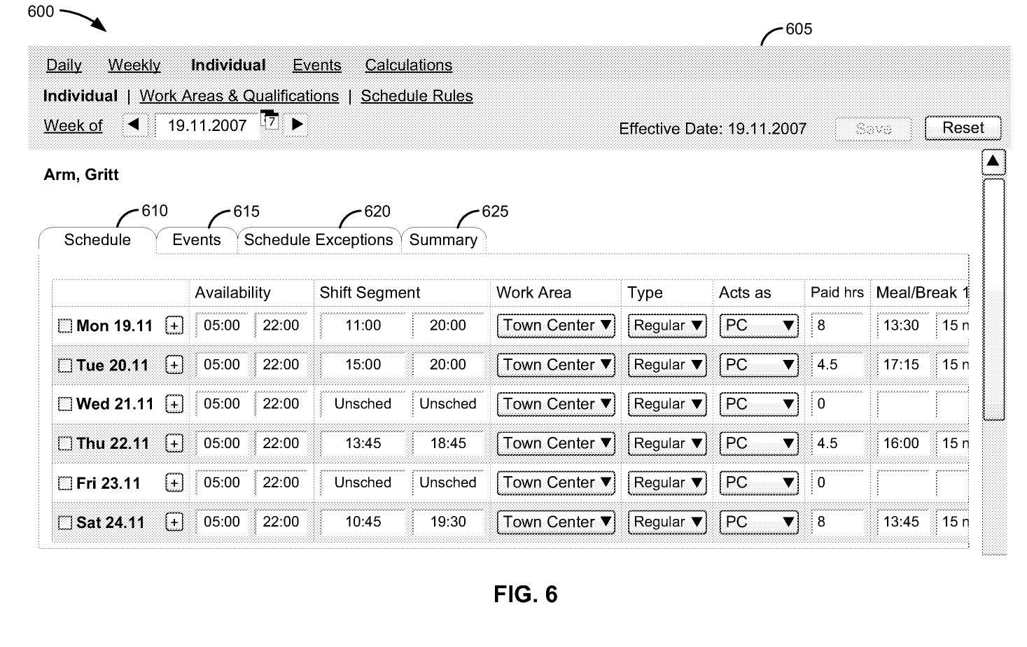

FIG. 6 illustrates an exemplary weekly schedule of an individual employee according to an embodiment of the invention. At business scenario 600, the day schedule screen 605 consists of action tabs such as “schedule” 610, “events” 615, “schedule exceptions” 620 and “summary” 625. On activating schedule 610, the day schedule screen 605 displays the schedule of employee Gritt Arm. The day schedule screen 605 also consists of columns illustrating “availability”, “shift segment”, “work area”, “type”, “act as”, “paid hours” and “meal break” associated with Gritt Arm. For example, on 19.11.2007 the shift segment column displays the shift timings for Gritt Arm as 11:00 hrs to 20:00 hrs, and the availability column displays that she is available from 05:00 hrs to 22:00 hrs. The work area assigned to her is displayed in the column “work area”. In this scenario 600, the work area assigned to her is Town Center, the “type” of work is regular, and she acts as a PC. Also, details of paid hours and the meal breaks associated with Gritt Arm are displayed in columns “Paid hrs” and “Meal Break” respectively.

In an embodiment, the tab “events” 615 provides a list of work assigned to Gritt Arm. The tab “schedule exceptions” 620 may provide details about the free time of Gritt Arm in the scheduled time. The tab “summary” 625 may provide details about the work summary of Gritt Arm for the entire week.

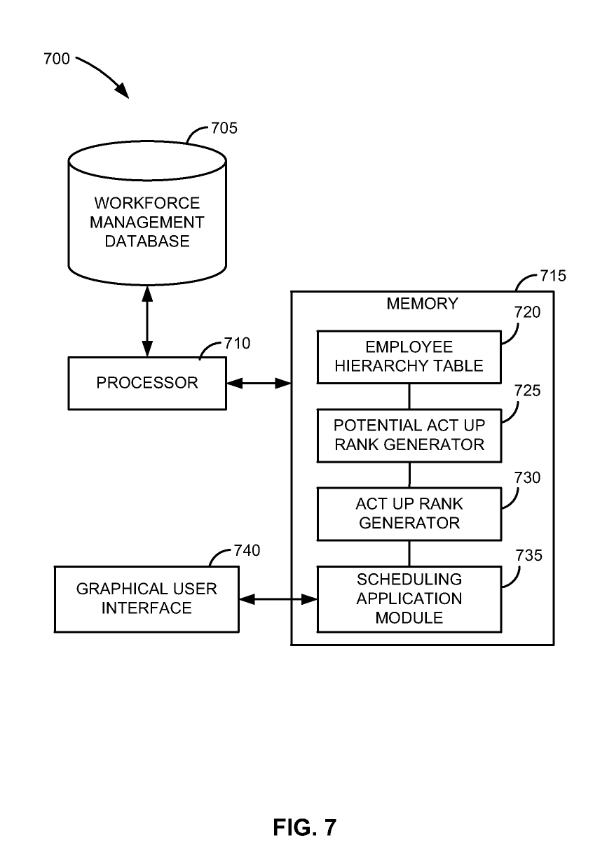

FIG. 7 is a block diagram to illustrate generating an act up rank of an employee based on a current rank and one or more qualifications of the employee according to an embodiment of the invention. In business scenario 700, a workforce management database 705 stores a current rank and the qualifications associated with an employee. Memory 715 consists of an employee hierarchy table 720, a potential act up rank generator 725, an act up rank generator 730 and a scheduling application module 735. A processor 710 retrieves the current rank and the qualifications associated with the employee from the workforce management database 705. The processor 710 also updates the employee hierarchy table 720 with the current rank and the qualifications. The potential act up rank generator 725 determines a potential act up rank based on the current rank and the qualifications. The potential act up rank is determined only if the employee satisfies the eligibility associated with the potential act up rank. The processor 710 updates the employee hierarchy table 720 with the potential act up rank. In an embodiment, the processor 710 compares the current rank and qualifications of the employee with the eligibility criteria required for the potential act up rank. If the employee satisfies the eligibility criteria required for the potential act up rank, then an act up rank is generated by act up rank generator 730.

In another embodiment, the act up rank generated by the act up rank generator 730 is updated to the employee hierarchy table 720. A scheduling application module 735 is updated with the act up rank by the processor 710. The scheduling application module 735 enables a scheduler to schedule tasks based on the preferences, availability and qualifications of the employee. The scheduling application is displayed on a graphical user interface 740. The graphical user interface 740 displays one or more schedules associated with the employee and one or more other employees. In an embodiment, the graphical user interface 740 displays an individual schedule screen associated with the employee. In another embodiment, the graphical user interface 740 displays a weekly schedule screen associated with the employee and one or more other employees. In yet another embodiment, the graphical user interface 740 displays a weekly schedule screen associated with one or more employees. The displayed weekly schedule screen associated with the employee and one or more other employees includes their respective actual rank, potential act up rank and scheduled rank

In another embodiment, the scheduler schedules a task based on the act up rank of the employee. There may be circumstances where an employee who needs to perform a task requiring a specific skill set is not available. Under such circumstances, the scheduler determines an employee who can act up to the task based on the act up rank.

Embodiments of the invention may include various steps as set forth above. The steps may be embodied in machine-executable program code which causes a general-purpose or special-purpose processor to perform certain steps. Alternatively, these steps may be performed by specific hardware components that contain hardwired logic for performing the steps, or by any combination of programmed computer components and custom hardware components.

Embodiments of the present invention may also be provided as a tangible machine-readable medium for storing the machine-executable instructions. The tangible CD-ROMs, DVD ROMs, RAMs, EPROMs, EEPROMs, magnetic or optical cards, or any other type of machine-readable media suitable for tangibly storing electronic instructions. The machine readable medium can provide the instructions stored therein to a computer system comprising a processor capable of reading and executing the instructions to implement the method steps described herein.

It should be appreciated that reference throughout this specification to one embodiment or an embodiment means that a particular feature, structure or characteristic described in connection with the embodiment is included in at least one embodiment of the present invention. These references are not necessarily all referring to the same embodiment. Furthermore, the particular features, structures or characteristics may be combined as suitable in one or more embodiments of the invention.

Throughout the foregoing description, for the purposes of explanation, numerous specific details were set forth in order to provide a thorough understanding of the invention. It will be apparent, however, to one skilled in the art that the invention may be practiced without some of these specific details. The detailed description as set forth above includes descriptions of method steps. However, one skilled in the art will understand that the order of the steps set forth above is meant for the purposes of illustration only and the claimed invention is not meant to be limited only to the specific order in which the steps are set forth. Accordingly, the scope and spirit of the invention should be judged in terms of the claims, which follow.

What is claimed is:

1. A machine readable storage medium comprising instructions which when executed by the machine cause the machine to perform operations comprising:
receiving a current rank and one or more qualifications associated with an employee from a workforce management application;
updating an employee hierarchy table with the current rank and the one or more qualifications of the employee;
based on the current rank and the one or more qualifications of the employee, determining a potential act up rank of the employee, wherein the potential act up rank specifies an eligibility of the employee to perform an act up task; and
updating the employee hierarchy table with the potential act up rank.

2. The machine readable storage medium of claim 1, wherein determining the potential act up rank of the employee comprises:
comparing the current rank and the one or more qualifications of the employee with potential act up rank eligibility criteria;
identifying one or more potential act up ranks whose eligibility criteria is met or exceeded by the current rank and the one or more qualifications of the employee; and
assigning at least one of the identified potential act up ranks as the potential act up rank of the employee.

3. The machine readable storage medium of claim 1, wherein the eligibility criteria of the employee to perform the act up comprises one or more qualifications associated with the potential act up rank.

4. The machine readable storage medium of claim 1, wherein the operations further comprise updating a scheduling application with a rank table.

5. The machine readable storage medium of claim 4, wherein updating the scheduling application with the rank table comprises updating the current rank, an act up rank and a scheduling rank of the rank table.

6. A computer implemented method for generating a potential act up rank of an employee based on a current rank and one or more qualifications of the employee, the computer implemented method comprising:
receiving the current rank and the one or more qualifications associated with the employee from a workforce management application;
updating an employee hierarchy table stored in a data store with the current rank and the one or more qualifications of the employee;
based on the current rank and the one or more qualifications of the employee, determining a potential act up rank of employee, wherein the potential act up rank specifies an eligibility of the employee to perform an act up task; and
updating the employee hierarchy table with the potential act up rank.

7. The computer implemented method of claim 6, wherein determining the potential act up rank of employee comprises:
comparing the current rank and the one or more qualifications of the employee with potential act up rank eligibility criteria;
identifying one or more potential act up ranks whose eligibility criteria is met or exceeded by the current rank and the one or more qualifications of the employee; and
assigning at least one of the identified potential act up ranks as the potential act up rank of the employee.

8. The computer implemented method of claim 7, further comprises assigning a task based on the act up rank of the employee.

9. The computer implemented method of claim of claim 8, wherein assigning the task based on the act up rank of the employee comprises:
receiving a request for scheduling employees to perform a task;
evaluating a schedule associated with the employees to determine if an employee with a current rank is available to perform the task; and
if the employee with the current rank is not available to perform the task, assigning the task to another employee satisfying a requirement of the task, based on the act up rank and availability.

10. The computer implemented method of claim 6 further comprises updating a user interface of a scheduling application displaying a rank table.

11. The computer implemented method of claim 10, wherein updating the user interface of the scheduling application with the rank table comprises updating the current rank, the act up rank and a scheduled rank displayed in the rank table.

12. The computer implemented method of claim 10, wherein the scheduling application comprises schedules of one or more employees.

13. A computer system for generating a potential act up rank of an employee based on a current rank and one or more qualifications of the employee, the computer system comprising:
an workforce management database to store the current rank and the one or more qualifications associated with the employee;
a processor in communication with the workforce management database and a memory operable to retrieve the current rank and one or more qualifications of the employee from the workforce management database and to update an employee hierarchy table in the memory with current rank and the one or more qualifications of the employee; and
a potential act up rank generator in the memory operable to cause the processor generate a potential act up rank associated with the employee based on the current rank and the one or more qualifications associated with the employee.

14. The computer system of claim 13, wherein the memory comprises a scheduling application module operable for scheduling employees to tasks.

15. The computer system of claim 14, wherein the scheduling application module further comprises one or more schedules associated with one or more employees.

16. The computer system of claim 13, wherein the processor updates an act up rank to a scheduling application module.

17. The computer system of claim 13 further comprising a graphical user interface operable for displaying one or more schedules associated with the employee and one or more other employees.

18. The computer system of claim 17, wherein the graphical user interface displays an individual schedule screen associated with the employee.

19. The computer system of claim 17, wherein the graphical user interface displays a weekly schedule screen associated with the employee and one or more other employees.

20. The computer system of claim 17, wherein the displayed weekly schedule screen associated with the employee and one or more other employees comprises their respective actual rank, potential act up rank and scheduled rank.
